(19) United States
(12) Patent Application Publication
(10) Pub. No.: US 2011/0178651 A1
(43) Pub. Date: Jul. 21, 2011

(54) System for Managing Electric-Power Demands in Real Time through AMI Gateway Sharing Public IP Network

(75) Inventors: Jung In Choi, Seoul (KR); Jae Kyu Lee, Seoul (KR)

(73) Assignee: Byucksan Power Co., Ltd.

(21) Appl. No.: 13/121,171

(22) PCT Filed: Jun. 30, 2009
(86) PCT No.: PCT/KR09/03534

§ 371 Date: Mar. 25, 2011

(30) Foreign Application Priority Data
Sep. 25, 2008 (KR) 10-2008-0094263
Apr. 7, 2009 (KR) 10-2009-0029828

(51) Int. Cl. G06F 1/28

(52) U.S. Cl. 700/295

(57) ABSTRACT

The present invention relates to a system for managing electric power demands in real time through an AMI gate way sharing a public IP network. The system obtains information about the electric power load of parts of a house or the entire house and manages basic data demands such as on/off operation or storage of a load. The system enables the sharing of the public IP network for external communication with an external demand management DB through an in-house AMI gateway box. In addition, the system allows ZigBee wireless communication for internal communication with an in-house digital gauge. Therefore, the system is able to secure demand management resources.

### TECHNICAL FIELD

The present invention relates, in general, to technology related to the construction of an Advanced Metering Infrastructure (AMI) that is the next-generation measuring infrastructure required for electric power demand side management, and, more particularly, to a system for managing electric-power demands in real time through AMI gateway sharing public Internet Protocol (IP) network, which is configured using technology for electric power measuring, technology for measuring information communication, gateway technology for such measuring information communication, and demand side management technology.

### BACKGROUND ART

In order to implement an AMI that is the next-generation measuring infrastructure, the construction of a two-way communication module between digital meters and the servers of electric power companies is required.

As digital meters, various types of commercial products that satisfy the specifications of electric power companies have already been released.

Therefore, in order for an electric power company or an electric power service provider to collect pieces of information measured by digital meters, to provide such measured information in the form of real-time fees or the like to customers, and to cause a demand response, two-way communication means must be provided between the digital meters and an electric power service server, and various types of technologies have been proposed as the technology for providing such communication means.

First, there is a means for external communication, wherein when this means is directly constructed in the server of an electric power company or an electric power service provider, Power Line Communication (PLC) and fixed wireless communication have been frequently used. When a public network is used, a Public Switched Telephone Network (PSTN) which is an existing wired/wireless telephone network, or a Code Division Multiple Access (CDMA) network, is used.

Compared to such a network, a public wideband Internet Protocol (IP) network is rarely used in terms of security and cost. However, when an Advanced Metering Infrastructure (AMI) is constructed using a leased line, or when a public wired/wireless telephone network is used, there is a limitation in terms of performance, and considerable construction and maintenance costs are caused.

Second, there is a communication means used within each customer, wherein a narrow band wired network using PLC or a telephone network has been used as such a communication means, and a wireless network, such as a Zigbee network, has recently been taken into consideration.

However, even in this case, there are obstacles to performing large-scale construction due to the difficulty and costs of installation, management, and maintenance.

In particular, in an actual situation, linking such a communication means to existing meters, existing load control devices or household electric appliances causes a large burden in terms of technology or costs.

### DISCLOSURE

### Technical Problem

Accordingly, the present invention has been made keeping in mind the above problems, and an object of the present invention is to provide a system for managing electric-power demands in real time through AMI gateway sharing public IP network, in which an AMI gateway, which allows a wideband public IP network to be used for external communication and allows Zigbee communication to be used for the internal communication of each customer, is constructed in the home of each customer.

Another object of the present invention is to provide a system for managing electric-power demands in real time through AMI gateway sharing public IP network, which automates the function of easily and conveniently sharing IP addresses without interfering with the use of existing IP addresses, using a Dynamic Host Configuration Protocol (DHCP) module and a Universal Plug and Play (UPnP) discovery module.

A further object of the present invention is to provide a system for managing electric-power demands in real time through AMI gateway sharing public IP network, which enables individual loads of a customer to be managed using an independent intelligent socket, thus performing Zigbee communication with the AMI gateway.

### Technical Solution

In accordance with the present invention to accomplish the above objects, there is provided a system for managing electric-power demands in real time through Advanced Metering Infrastructure (AMI) gateway sharing public Internet Protocol (IP) network, including at least one load management module for acquiring electric power information or signal information related to each load of a customer or operating in response to received control information, the load management module comprising a communication module which transmits or receives the electric power information or the control information in a wireless manner; an AMI gateway for receiving the electric power information or the signal information transmitted in a wireless manner from the load management module, transferring the received information over a public Internet Protocol (IP) network, and transferring the control information received over the public IP network to the load management module; and an AMI service server for managing and calculating the electric power information and the signal information of the load management module, which are received from the AMI gateway over the public IP network, generating the control information required to control the load management module, and transferring the control information to the AMI gateway, wherein status of the load management module is checked and a control command for the load management module is executed based on the electric power information and the signal information on a web page of the AMI service server accessed by a user terminal.

Further, according to the present invention, the load management module may be one or more of a digital meter for measuring power consumption, a premises temperature controller, and an intelligent socket.

Furthermore, according to the present invention, the user terminal may be one of a notebook computer, a mobile communication terminal, a Personal Computer (PC), and a Personal Digital Assistant (PDA), and the AMI service server includes a demand side management program therein so that power consumption information of each home is checked on a web page of the user terminal or the load management module is controlled using the demand side management program.

Furthermore, according to the present invention, the AMI service server may be linked to a manager module of the AMI service server or an Energy Management System (EMS), thus controlling the load management module.

Furthermore, according to the present invention, the AMI gateway, which is installed in each home which is a minimum customer, may include an IP communication module for making a connection to the AMI service server over the public IP network; a Zigbee communication module for receiving the electric power information and a status signal of the load management module and transmitting a control signal so that communication with the load management module is performed in a wireless manner; an algorithm module implemented on an ARM chip; and a power module for supplying electric power to a circuit.

Furthermore, according to the present invention, the IP communication module may include a Dynamic Host Configuration Protocol (DHCP) module for automatically receiving an IP address from a public Internet service provider so as to automatically set an IP address, and performing setting such that an existing device that has already been connected to the DHCP module automatically shares the received IP address; and a Universal Plug and Play (UPnP) module for automatically discovering existence of hardware of the AMI gateway and allowing the service server or a sharer to identify the hardware, wherein when a terminal of the AMI gateway is connected to an internet terminal on a surface of a wall and a port of a device that has already been connected is connected to a port of the AMI gateway, the IP address is automatically set.

Furthermore, according to the present invention, the DHCP module and the UPnP module transmit an identification number included in the AMI gateway to the AMI service server so that the identification number is registered, and the identification number of the AMI gateway may be entered into a webpage accessed by the user terminal so that the AMI gateway is authenticated.

### Advantageous Effects

The system for managing electric-power demands in real time through AMI gateway sharing public IP network according to the present invention, based on the above technical solution, performs communication between the AMI gateway and an external service server by sharing an existing public IP network that has been being used, so that the construction of an AMI that is the next-generation measuring infrastructure can be very efficiently performed, thus maximizing communication performance and minimizing costs.

Further, the system for managing electric-power demands in real time through AMI gateway sharing public IP network according to the present invention does not influence the use of existing IP addresses by using the automatic IP address sharing and setting function of the gateway, thus eliminating additional inconveniences attributable to installation and enabling the AMI gateway to be smoothly spread to ordinary households.

Furthermore, the system for managing electric-power demands in real time through AMI gateway sharing public IP network according to the present invention uses Zigbee communication, which is universal wireless communication, for internal communication, thus minimizing the cost of manufacturing the AMI gateway, and also manages individual loads using an intelligent socket even when meters, temperature controllers, or the like are constructed in advance and linking the AMI gateway to those components is difficult, thus easily acquiring a large number of demand side management resources.

Using the above-described construction method, an electric power company can extend the spreading of an AMI and can obtain efficient peak power reduction effects via demand side management, and a user can reduce power rates. The present invention can be applied even to gas or water metering, in addition to electric power metering, in various manners.

### DESCRIPTION OF DRAWINGS

FIG. 1 is an entire system configuration diagram showing a system for managing electric-power demands in real time through AMI gateway sharing public IP network according to the present invention;

FIG. 2 is a block diagram showing the internal construction of the AMI gateway 100 of FIG. 1; and

FIG. 3 is a diagram showing the construction of an intelligent socket and the AMI gateway 100.

* Description of reference numerals of
principal elements in the drawings *

| | |
|---|---|
| 10: digital meter | 20: temperature controller |
| 30: intelligent socket | 31: load |
| 100: AMI gateway | 110: DHCP |
| 120: UPnP discovery | 130: Zigbee stack |
| 140: Zigbee communication module | 150: MAC |
| 200: AMI service server | 210: AMI web server |

### BEST MODE

Hereinafter, embodiments of a system for managing electric-power demands in real time through AMI gateway sharing public IP network according to the present invention will be described in detail with reference to the attached drawings.

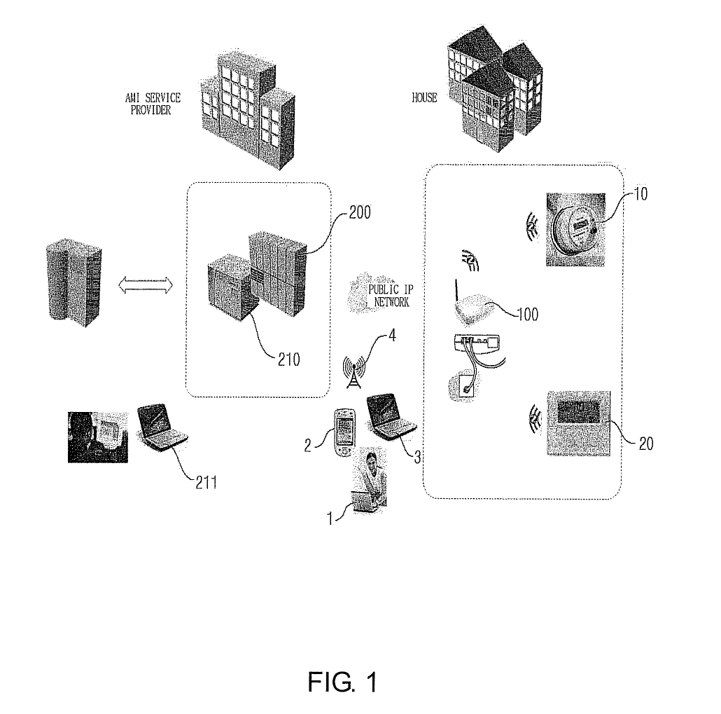

As shown in FIG. 1, a system for managing electric-power demands in real time through AMI gateway sharing public IP network according to the present invention includes an AMI service server 200 which is constructed on an AMI service provider side, and an AMI gateway 100 and load management modules (in the drawing, a digital meter 10 and a temperature controller 20) which are installed in each home.

The AMI service server 200 is connected to the AMI gateway 100, which will be described below, over a public IP network, and then manages and calculates data about the electric power information of the load management modules.

The electric power information corresponds to real-time power consumption measured by the digital meter, status signal information indicated by the temperature controller or the like, etc.

For this operation, the AMI service server 200 includes therein a demand side management program, and includes an AMI web server 210 installed therein, so that a user can access the AMI web server 210 using a terminal (a notebook 2 or a desktop PC 1) anytime and anywhere over the public IP network, and can check information about power consumption occurring at his or her home on a web page or can control (demand response) a relevant load management module (a premises temperature controller or the like) using the demand side management program.

Further, the user can also access the AMI web server 210 using his or her mobile phone 2 over a wireless network 4 and can be provided with the same service as the above service.

That is, the AMI service server 200 manages and executes all pieces of data and all service algorithms, thus providing robust and various types of services to final consumers over the wireless/wired Internet.

The AMI service server 200 may allow data to be managed using a manager module by the operator of the AMI or a demand side management server or may work in conjunction with the Energy Management System (EMS) of an electric power company or the Korea power exchange.

The AMI gateway 100 is installed in each home which is a minimum customer, and is composed of an IP communication module, a Zigbee communication module, an algorithm module implemented on an ARM chip, and a power module.

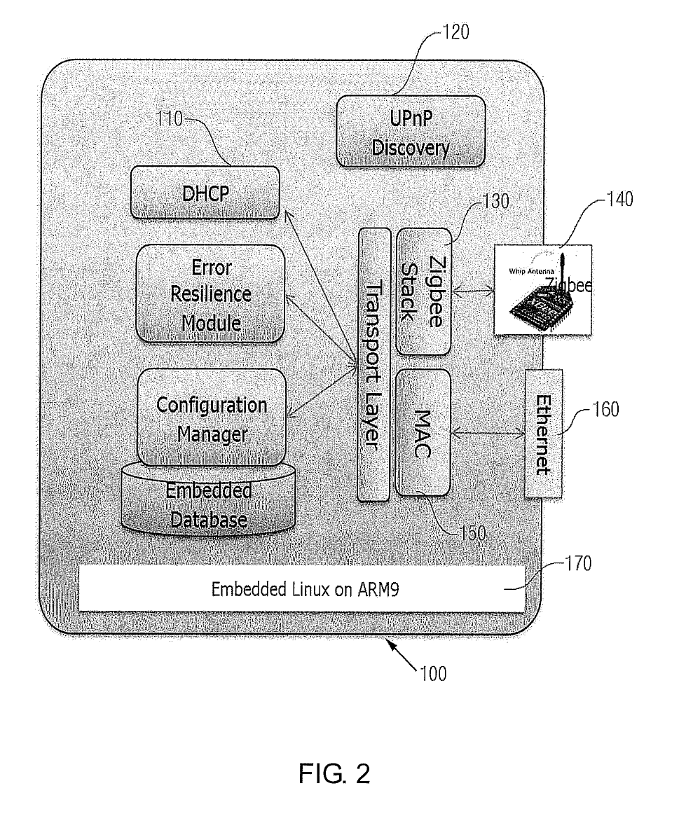

The AMI gateway 100 is constructed, as shown in FIG. 2, in such a way that an Operating System (OS) 170 such as embedded Linux is implemented on an ARM main chip and that a Media Access Control (MAC) module 150 for Ethernet (Transmission Control Protocol/Internet Protocol: TCP/IP) communication 160 and a Zigbee stack 130 for Zigbee communication 140 are implemented on the OS 170.

A Dynamic Host Configuration Protocol (DHCP) module 110 automatically receives an IP address from a public Internet service provider so as to automatically set an IP address, and performs setting such that a device already connected to this module automatically shares the received IP address.

A Universal Plug and Play (UPnP) module 120 functions to automatically discover and identify the existence of hardware of the AMI gateway 100, and allows either the service server or a sharer to identify the hardware.

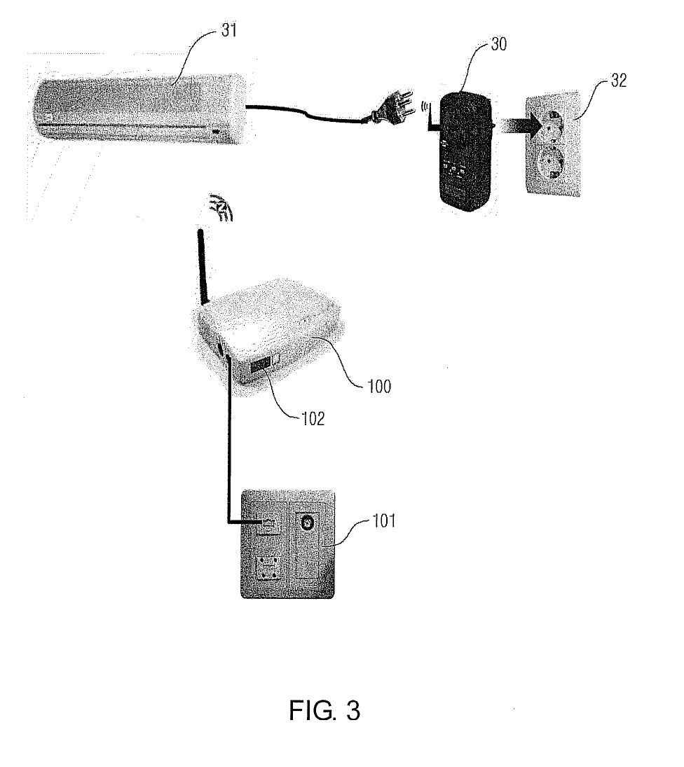

As shown in FIG. 3, the UPnP module 120 includes, in hardware construction, a power module, an Ethernet port for the connection of an external terminal 101 on the surface of a wall, an Ethernet port for the connection of an existing device that has been used, a Zigbee antenna, and a power plug.

Further, the AMI gateway 100 includes an ARM main chip therein.

The AMI gateway 100 is connected to a public IP network terminal attached to the wall through the IP module, and is then connected to the AMI service server 200 of the electric power service provider via the public IP network. The AMI gateway 100 exchanges required information with the load management modules, on which Zigbee modules are mounted, through the Zigbee modules.

The load management modules correspond to a standard digital meter, a temperature controller, an intelligent socket, etc.

As shown in FIG. 3, the intelligent socket is an independently manufactured socket, unlike an authenticated digital meter provided by an electric power company, and is configured to measure the electric power information of each individual load 31 connected to an intelligent socket 30, transmit the electric power information to the AMI gateway 100 using Zigbee communication, and receive simple control signals from the AMI gateway 100 so that power ON/OFF operations can be performed.

When electric power is supplied to the AMI gateway 100, the Zigbee communication of the digital meter or the temperature controller is automatically linked to the Zigbee communication of the AMI gateway 100. Automatic setting is performed in such a way that the AMI gateway 100 is connected to the Internet terminal on the surface of the wall at home where the Internet is used, and that a device already connected thereto is disconnected from the terminal on the wall surface and is connected to the corresponding port of the AMI gateway 100.

This allows the DHCP and UPnP modules to transmit an identification number, included in the AMI gateway 100, to the AMI service server 200, so that the identification number is immediately registered.

The user accesses an AMI website over the Internet, enters an identification number written on the AMI gateway 100 into the screen of the web, and allows the AMI gateway to be authenticated.

In this case, a method of additionally authenticating the AMI gateway to prevent the user from accessing another AMI gateway due to an error made with the entry or the like is configured to allow an authentication number, displayed on a reset button attached to the AMI gateway or the display screen of the gateway, to be entered.

Thereafter, in the case where an ID and a password have been set on the registration page, if the user logs into the website later using the ID and the password, a service page appears, and information about the current electric power consumption of his or her home is provided on the service page at the same time that a plurality of pieces of demand side management information are provided on the service page.

From this page, the user can select various types of demand side management programs and can control a load such as the temperature controller registered in the AMI gateway 100.

If a load management program is selected, the load of the home is automatically adjusted at a preset time by the selected program, and incentive information, which indicates the effect of such adjustment, is provided in real time.

Further, the user may be provided with a service using a mobile phone in such a way that when the user accesses the wireless Internet website of the AMI service server using the mobile phone and is initially authenticated in the same manner, a service similar to that of the web can be provided only if the user subsequently accesses the website using the same mobile phone as the above phone and merely enters only a password.

Furthermore, all communication between the AMI gateway 100 and the AMI service server 200 is equipped with a universal common security function, and thus the risk of hacking is removed.

In this case, when a digital meter or a load control device is already mounted, and it is difficult to link the AMI gateway 100 thereto, the AMI gateway 100 and the intelligent socket 30 are independently provided, so that the provision and control of demand information related to each individual load can be performed.

That is, when the AMI gateway 100 and the intelligent socket 30 are provided to an ordinary home as a single set, the customer connects the AMI gateway 100 to an IP port which has already been used, attaches the intelligent socket 30 to a power source on the surface of the wall, and connects individual household electric appliances, such as an air conditioner and a washing machine which are the targets of the demand side management of the intelligent socket 30, to the intelligent socket 30, thus completing the installation of the system.

This socket has therein the function of measuring information about power consumption, and transmits measured information to the AMI gateway via the Zigbee communication of the intelligent socket.

The AMI gateway 100 transmits the measured information to the AMI service server in real time over the IP network, receives a demand side management command, and transmits the demand side management command to the intelligent socket.

The controller of the intelligent socket can participate in an automatic demand side management program by automatically turning on/off a relevant load in compliance with the command.

The reduction of the loads can be checked by measuring variations in the electric power demands. This structure is further extended and configured in the form of a multi-tap structure, so that a number of loads can simultaneously participate in the automatic demand side management program. In the future, a small-sized storage device is mounted, so that load management can be more efficiently performed.

Further, a control device for various household electric appliances in a home network system, as well as the temperature controller, is included in the load management modules, thereby enabling the home network system to be remotely controlled using a user's remote terminal.

1. A system for managing electric-power demands in real time through Advanced Metering Infrastructure (AMI) gateway sharing public Internet Protocol (IP) network, comprising:
at least one load management module for acquiring electric power information or signal information related to each load of a customer or operating in response to received control information, the load management module comprising a communication module which transmits or receives the electric power information or the control information in a wireless manner;
an AMI gateway for receiving the electric power information or the signal information transmitted in a wireless manner from the load management module, transferring the received information over a public Internet Protocol (IP) network, and transferring the control information received over the public IP network to the load management module; and
an AMI service server for managing and calculating the electric power information and the signal information of the load management module, which are received from the AMI gateway over the public IP network, generating the control information required to control the load management module, and transferring the control information to the AMI gateway,
wherein status of the load management module is checked and a control command for the load management module is executed based on the electric power information and the signal information on a web page of the AMI service server accessed by a user terminal.

2. The system for managing electric-power demands according to claim 1, wherein the load management module is one or more of a digital meter for measuring power consumption, a premises temperature controller, and an intelligent socket.

3. The system for managing electric-power demands according to claim 1, wherein the user terminal is one of a notebook computer, a mobile communication terminal, a Personal Computer (PC), and a Personal Digital Assistant (PDA), and the AMI service server includes a demand side management program therein so that power consumption information of each home is checked on a web page of the user terminal or the load management module is controlled using the demand side management program.

4. The system for managing electric-power demands according to claim 1, wherein the AMI service server is linked to a manager module of the AMI service server or an Energy Management System (EMS), thus controlling the load management module.

5. The system for managing electric-power demands according to claim 1, wherein the AMI gateway, which is installed in each home which is a minimum customer, comprises:
an IP communication module for making a connection to the AMI service server over the public IP network;
a Zigbee communication module for receiving the electric power information and a status signal of the load management module and transmitting a control signal so that communication with the load management module is performed in a wireless manner;
an algorithm module implemented on an ARM chip; and
a power module for supplying electric power to a circuit.

6. The system for managing electric-power demands according to claim 5, wherein the IP communication module comprises:
a Dynamic Host Configuration Protocol (DHCP) module for automatically receiving an IP address from a public Internet service provider so as to automatically set an IP address, and performing setting such that an existing device that has already been connected to the DHCP module automatically shares the received IP address; and
a Universal Plug and Play (UPnP) module for automatically discovering existence of hardware of the AMI gateway and allowing the service server or a sharer to identify the hardware,
wherein when a terminal of the AMI gateway is connected to an internet terminal on a surface of a wall and a port of a device that has already been connected is connected to a port of the AMI gateway, the IP address is automatically set.

7. The system for managing electric-power demands according to claim 6, wherein the DHCP module and the UPnP module transmit an identification number included in the AMI gateway to the AMI service server so that the identification number is registered, and wherein the identification number of the AMI gateway is entered into a webpage accessed by the user terminal so that the AMI gateway is authenticated.
